(19) United States
(12) Patent Application Publication
(10) Pub. No.: US 2007/0053349 A1
(43) Pub. Date: Mar. 8, 2007

(54) Network interface accessing multiple sized memory segments

(76) Inventors: Bryan Rittmeyer, Sherman Oaks, CA (US); Alon Regev, Woodland Hills, CA (US)

Correspondence Address: SoCAL IP LAW GROUP LLP, 310 N. WESTLAKE BLVD. STE 120, WESTLAKE VILLAGE, CA, 91362, US

(21) Appl. No.: 11/219,454

(22) Filed: Sep. 2, 2005

(51) Int. Cl. H04L 12/50

(52) U.S. Cl. 370/378

(57) ABSTRACT

A network interface that accesses multiple sized memory segments is disclosed. In a method, a data unit is received and its size is evaluated. A group of memory segments is selected from a plurality of groups of memory segments based on the size of the data unit. The selected group of memory segments has a plurality of memory segments large enough to accommodate the incoming data unit. A memory segment from the selected group is allocated memory. The data unit is stored in the memory segment. The methods may be achieved in a network interface included in, for example, a network card, a network testing system and a computer.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND OF THE INVENTION

1. Field Of The Invention

The invention relates to network communications and the transmission of and receipt of network traffic.

2. Related Art

Networks such as the Internet carry a variety of data communicated using a variety of network devices including servers, routers, hubs, switches, and other devices. Before placing a network into use, the network, including the network devices, network media, network segments and network applications included therein, may be tested to ensure successful operation. Network devices and applications may be tested, for example, to ensure that they function as intended, comply with supported protocols, and can withstand anticipated traffic demands. Such testing may also be performed on already deployed network devices, network segments and network applications.

To assist with the construction, installation and maintenance of networks, network applications and network devices, networks may be augmented with network analyzing devices, network conformance systems, network monitoring devices, and network traffic generators, all which are referred to herein as network testing systems. The network testing systems may allow for analyzing the performance of networks, network applications and network devices by capturing, modifying, analyzing and/or sending network communications. The network testing systems may be used to evaluate the how well a network or portion of thereof handles streaming media and voice communications.

Network testing systems send and receive a large amount of network traffic and establish and end many communication sessions. Network interface devices, units, cards, chips and the like perform much of the work in sending and receiving network traffic and establishing and ending sessions. There is substantial computational and processing overhead in memory allocation and management when handling network traffic.

Commonly, network interfaces process data used in network traffic by placing the data in a first-in-first-out (FIFO) accessible memory location. Portions of the memory are allocated to the network traffic in sizes to accommodate the data in the network traffic. Substantial computational and memory management overhead is incurred in provided the specific memory segment sized to conform the data in the network traffic. Some implementations of network interfaces use fixed size, pre-allocated memory segments of a size large enough to handle the maximum allowed amount of data to store all network traffic. Although this reduces memory management overhead, it results in a lot of wasted memory, as network traffic smaller than the fixed size memory segments is placed in larger memory segments. In addition, the memory segments must be cleared before being refilled, which adds to the overhead. Other implementations of network interfaces use fixed size, pre-allocated memory segments of a small size to store all network traffic. In this implementation, when medium or large amounts of data are included in network traffic, the network interface must allocate multiple memory segments to accommodate the data. This implementation results in high memory management overhead and packet processing cost for medium and large data bearing network traffic.

### DESCRIPTION OF THE DRAWINGS

FIG. 1 is a block diagram of an environment in which a network interface as described herein is included in a network card in a network testing system.

FIG. 2 is a block diagram of a network card in which a network interface as described herein is included.

FIG. 3 is a block diagram of an environment in which a network interface as described herein is included in a computer.

FIG. 4 is a flow chart of a method performed when receiving data units via a network interface device as described herein.

FIG. 5 is a flow chart of a method performed when sending data units via a network interface device as described herein.

### DETAILED DESCRIPTION OF THE INVENTION

Throughout this description, the embodiments and examples shown should be considered as exemplars, rather than limitations on the apparatus and methods described.

Device and Systems

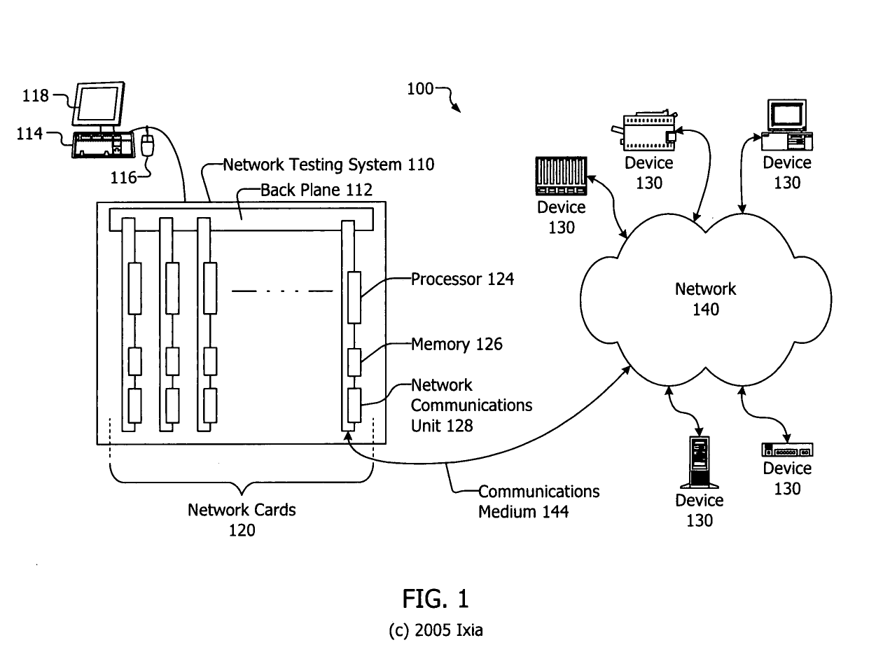

FIG. 1 is a block diagram of an environment in which a network interface as described herein is included in a network card in a network testing system. The environment 100 includes network testing system 110 coupled via a network card 120 to a network 140 over a communications medium 144. The network testing system 110 may include or be one or more of a performance analyzer, a conformance validation system, a network analyzer, a packet blaster, a network management system, a combination of these, and/or others. The network testing system 110 may be used to evaluate or measure characteristics and performance of a communication line or system, including the throughput of network traffic, the number of dropped packets, jitter, and other characteristics and performance. Such testing may be used to evaluate the Mean Opinion Score (MOS) of voice transmission over a network or portion thereof. The network testing system 110 may be used to evaluate the performance of servers, networking devices such as, for example, routers, gateways, load sharers, and others, as well as network applications and other software. That is, the network testing system 110 may be used to test and evaluate the network 140 and/or portions thereof, network capable devices 130, applications running on network capable devices 130, and/or services provided by network 140 and/or network capable devices 130.

The network testing system 110 may be in the form of a chassis or card rack, as shown in FIG. 1, or may be an integrated unit. Alternatively, the network testing system may comprise a number of separate units such as two or more chassis cooperating to provide network analysis, network conformance testing, and other tasks. The chassis of the network testing system 110 may include one or more network cards 120 and a back plane 112. The network cards 120 may be coupled with back plane 112. One or more network cards 120 may be included in network testing system 110. The network cards 120 may be permanently installed in the network testing system 110, may be removable, or may be a combination thereof.

The network testing system 110 and/or one or more of the network cards 120 may include an operating system such as, for example, versions of Linux, Unix and Microsoft Windows.

At least one network card 120 is coupled with network 140 via a communications medium 144. Although only one connection over communications medium 144 is shown, each of the network cards 120 may be connected with network 140 over a communications medium. In addition, in some embodiments, each network card may have two or more connections with network 140 or two or more networks. The communications medium may be, for example, wire lines such as an Ethernet cable, fibre optic cable, and coaxial cable, and may be wireless.

The network testing system 110 and the network cards 120 may support one or more well known higher level communications standards or protocols such as, for example, one or more versions of the User Datagram Protocol (UDP), Transmission Control Protocol (TCP), Internet Protocol (IP), Internet Control Message Protocol (ICMP), Internet Group Management Protocol (IGMP), Session Initiation Protocol (SIP), Hypertext Transfer Protocol (HTTP), address resolution protocol (ARP), reverse address resolution protocol (RARP), file transfer protocol (FTP), Simple Mail Transfer Protocol (SMTP); may support one or more well known lower level communications standards or protocols such as, for example, the 10 and/or 40 Gigabit Ethernet standards, the Fibre Channel standards, one or more varieties of the IEEE 802 Ethernet standards, Asynchronous Transfer Mode (ATM), X.25, Integrated Services Digital Network (ISDN), token ring, frame relay, Point to Point Protocol (PPP), Fiber Distributed Data Interface (FDDI), Universal Serial Bus (USB), IEEE 1394 (also known as i.link® and Firewire®); may support proprietary protocols; and may support other protocols. Each network card 120 may support a single communications protocol, may support a number of related protocols, or may support a number or combination of unrelated protocols.

The term “network card” as used herein encompasses line cards, test cards, analysis cards, network line cards, load modules, interface cards, network interface cards, data interface cards, packet engine cards, service cards, smart cards, switch cards, relay access cards, CPU cards, port cards, and others. The network cards 120 may be referred to as blades, particularly when a processor is included on the network card.

The network cards 120 may include one or more processors 124, memory 126 such as a version of random access memory (RAM), and one or more network communications units 128. In another embodiment, the network cards 120 may have no processors 124 and may include one or more network communications units 128. In the embodiment in which the network cards do not include a processor, processing may be performed by a processor on the motherboard, on another card, on the backplane or by a remote or external unit. When the network card 120 includes two or more network communications units 128, the network card 120 is in effect two or more network capable devices. That is, a network card 120 having n network communications units 128 may function as n network capable devices.

The network communications unit 128 may be implemented as one or more field programmable gate arrays (FPGA), application specific integrated circuits (ASIC), programmable logic devices (PLD), programmable logic arrays (PLA), other kinds of devices, and combinations of these. The network interface described herein may be implemented using the network communications unit 128. The network communications unit 128 may support one or more communications protocols in hardware. The network communications unit 128 may include a network interface through which the network card 120 may transmit and/or receive communications over the network 140.

The back plane 112 may serve as a bus or communications medium for the network cards 120. The back plane 112 may also provide power to the network cards 120.

The network testing system 110 may have coupled therewith a display 118 and user input devices such as a keyboard 114 and a mouse 116, as well as other user input devices including, for example, pens and trackballs. The user input devices may be coupled to a network card, other card, motherboard, or backplane included in the chassis. The network testing system 110 may have a computer (not shown) coupled thereto. The computer may be local to or remote from the network testing system 110. In another embodiment, the network testing system 110 may include a CPU on a card, motherboard or backplane that allows the chassis to also serve as a computer workstation.

The network testing system 110 may be implemented in a computer such as a personal computer, server, or workstation, as well as the chassis shown. The network testing system 110 may be used alone or in conjunction with one or more other network testing systems 110. The network testing system 110 may be located physically adjacent to and/or remote to the network capable devices 130 in the network 140.

The network 140 may be a local area network (LAN), a wide area network (WAN), a storage area network (SAN), or a combination of these. The network 140 may be wired, wireless, or a combination of these. The network 140 may include or be the Internet. The network 140 may be public or private, may be a segregated test network, and may be a combination of these. The network 140 may be comprised of a single or numerous nodes providing numerous physical and logical paths for data units to travel. Each node may be a network capable device as described below.

Communications on the network 140 may take various forms, including frames, cells, datagrams, packets, higher level logical groupings, or other units of information, all of which are referred to herein as data units. Those data units that are communicated over a network are referred to herein as network traffic. The network traffic may include data units that represent electronic mail messages, text messages, streaming media such as music (audio) and video, telephone (voice) conversations, web pages, graphics, documents, and others. The data units may vary in size.

The network capable devices 130 may be devices capable of communicating over the network 140 and/or listening to, injecting, delaying, dropping, and/or modifying network traffic on network 140. The network capable devices 130 may be computing devices such as computer workstations, personal computers, servers, portable computers, set-top boxes, video game systems, personal video recorders, telephones, personal digital assistants (PDAs), computing tablets, and the like; peripheral devices such as printers, scanners, facsimile machines and the like; network capable storage devices including disk drives such as network attached storage (NAS) and SAN devices; network testing equipment such as analyzing devices, network conformance systems, emulation systems, network monitoring devices, and network traffic generators; components such as processors, network cards and network communications units; and networking devices such as routers, relays, firewalls, hubs, switches, bridges, traffic accelerators, and multiplexers. In addition, the network capable devices 130 may include appliances such as refrigerators, washing machines, and the like as well as residential or commercial heating, ventilation, and air conditioning (HVAC) systems, alarm systems, and other devices or systems capable of communicating over a network. One or more of the network capable devices 130 may be devices to be tested and may be referred to as devices under test.

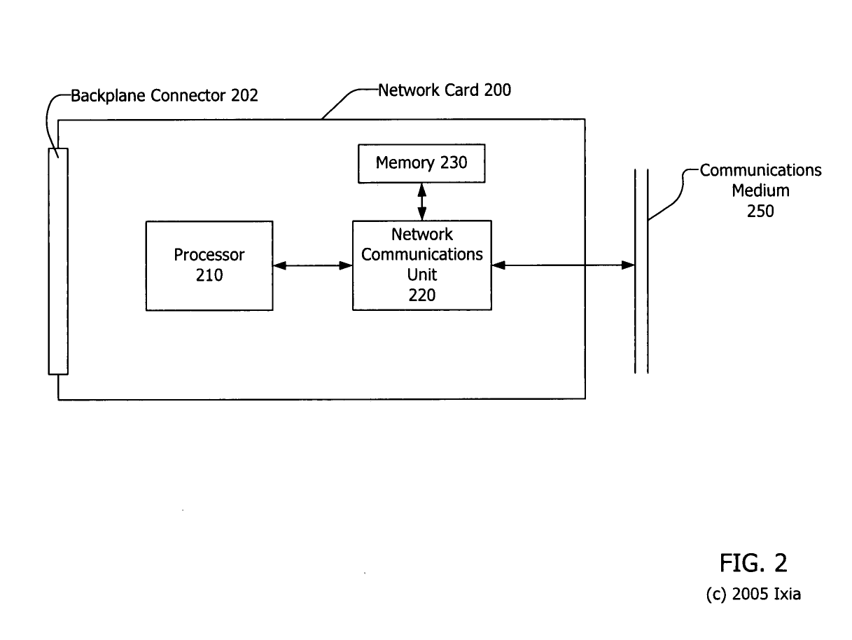

FIG. 2 is a block diagram of a network card 200 in which a network interface as described herein is included. The network card 200 may include hardware, software, firmware, and/or a combination thereof. The network card may include a processor 210, a network communications unit 220, a memory unit 230, and a backplane connector 202. The network card 200 may include other components and connectors, not shown. In another embodiment, there are no processors 210 in the network card 200. The network card 200 may have one or more network communications units 220. The network card 200 may also have one or more memory units 230 and one or more processors 210 included thereon. The network card 200 may include an operating system or a real-time operating system.

The backplane connector 202 may allow the network card 200 to be coupled with a network testing system such as network testing system 110. The memory 230 may be, for example, RAM, and may be coupled with processor 210. The processor 210 may be a multipurpose processor, such as, for example, a PowerPC processor available from IBM, Inc., and may be a specialized processor. The processor 210 may be coupled with the network communications unit 220. The processor is capable of executing instructions which may be located in a local memory, other storage medium, or other local or remote storage device. In one embodiment, the network card 200 includes no processor, and commands are received from a processor included on another card, on a mother board, or on a backplane.

The network card 200 may include and/or have access to local and/or remote memory, storage media and storage devices. Instructions to be executed by the processor may be stored on and executed from any local or remote machine readable medium or storage device. A machine readable medium includes, for example, without limitation, magnetic media (e.g., hard disks, tape, floppy disks), optical media (e.g., CD, DVD), flash memory products (e.g., memory stick, compact flash and others), and volatile and non-volatile silicon memory products (e.g., random access memory (RAM), programmable read-only memory (PROM), electronically erasable programmable read-only memory (EEPROM), and others). A storage device is a device that allows for the reading from and/or writing to a machine readable medium. Storage devices include hard disk drives, DVD drives, flash memory devices, and others.

The network communications unit 220 may include one or more circuits, chips, logic, firmware and/or instructions that allow for communication of data units over a network and the allocation of memory for the processing of incoming and outgoing data units. The network communications unit 220 may provide support for the lower and/or higher level communications standards or protocols described above. The network communications unit 220 may provide support for the data link layer (DLL) of the OSI model. The network communications unit 220 may be implemented as one or more FPGAs. The FPGA may include or be coupled with a general purpose processor 210, memory 230 such as RAM, and other devices or components on network card 200. The network communications unit 220 may also be implemented or included on an ASIC, a silicon device, an integrated circuit, a general purpose processor, a specialized processor such as a network processor, or other device.

The network communications unit 220 may be coupled with a communications medium 250. The communications medium 250 may be a wire such as Ethernet cabling, coaxial cable, fibre optic cable, and others, and may be wireless.

Additional and fewer units, hardware and firmware may be included in the network card 200 to achieve the network interface described herein.

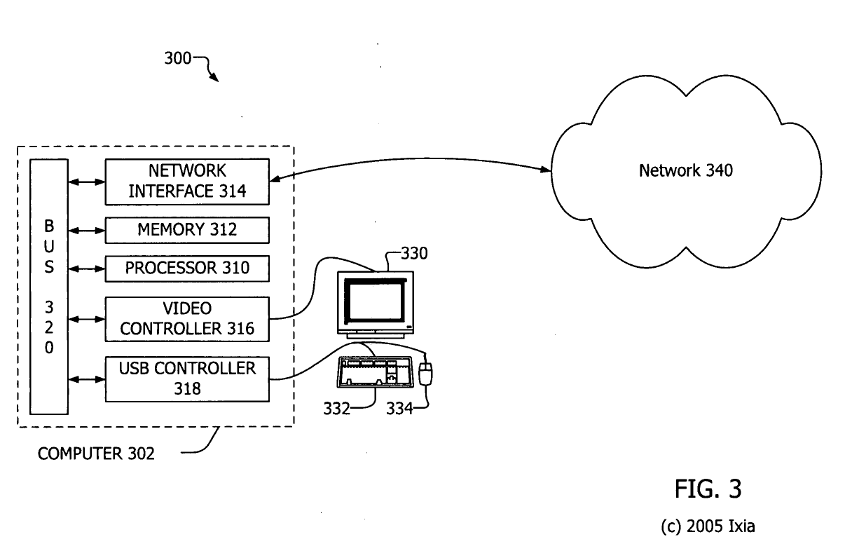

FIG. 3 is a block diagram of an environment 300 in which a network interface 314 as described herein is included in computer 302. The computer 302 may be any computing device, and may be a personal computer or a server computer. The computer 302 includes processor 310 memory 312, network interface 314, video controller 316 and USB controller 318 all coupled with bus 320. Although depicted as a single bus, bus 320 may be one or more buses. The processor 310 may be general purpose computer processor or microprocessor such as the Pentium® line of processors manufactured by Intel Corporation of Santa Clara, Calif. The memory 312 may be RAM. Optionally, user input may be received via USB controller 314 to which user input devices, such as keyboard 332, mouse 334, trackball (not shown), pen and tablet (not shown), etc., are connected. Optionally, graphics, images, and text may be presented to a user by video controller 316 to which display 330 is coupled.

Network interface 314 is similar to and performs the same or similar functionality of network communications units 128 and 220 shown in FIGS. 1 and 2. Network interface 314 provides support for the lower and/or higher communications protocols and standards described above. Network interface 314 allows the computer 302 to communicate over network 340. Network 340 is the same as or is similar to network 140.

Network interface 314 may be implemented as a chip or chipset on a motherboard or main board of a computer or other computing device, may be implemented as a chip or chip set on a network interface card (NIC) coupled to or included in a computer or computing device, and may otherwise communicate with, have access to, and/or be accessible to processor 310 and memory 312.

Referring now to FIGS. 1, 2 and 3, computer instructions in the form of higher level software programs, object code, assembly language code, JAVA applets, or other instructions may communicated to and stored on a storage device which may be coupled locally or may be accessible via electrical, optical, wireless, acoustic, and other means from a remote source, including via a network. These instructions may be executed to implement the network interface of the network communications unit 128 and 220 and the network interface 314. These instructions may be used to update or upgrade the network interface or network communications unit and be executed only once, or may be executed each and every time the network testing system 110, computer 302 or other computing device that implements the network interface described herein is powered up, started or restarted.

Methods

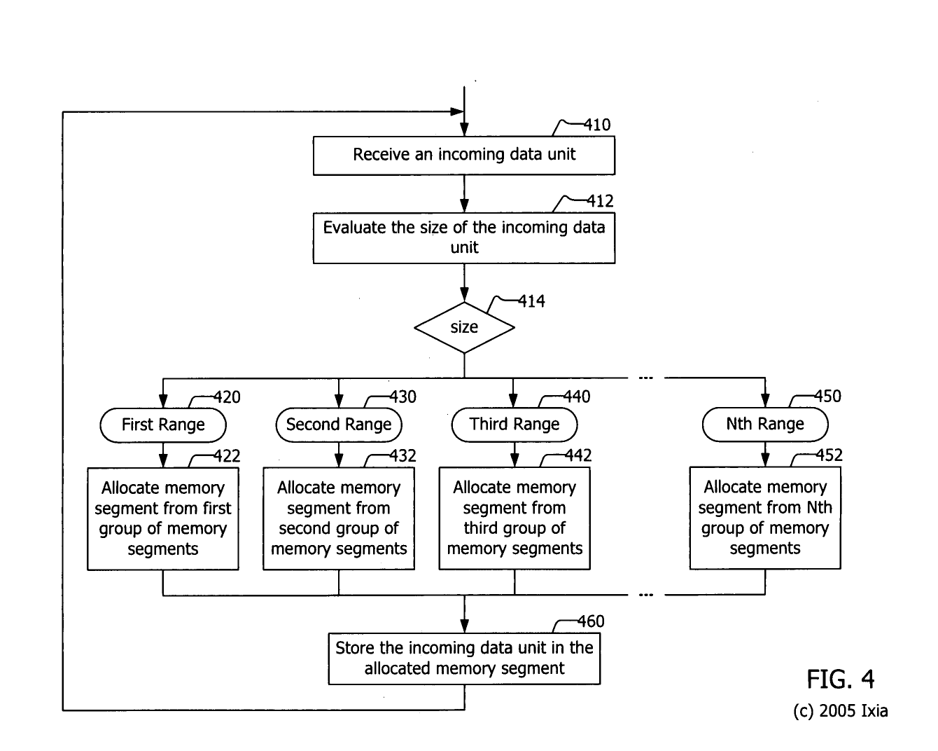

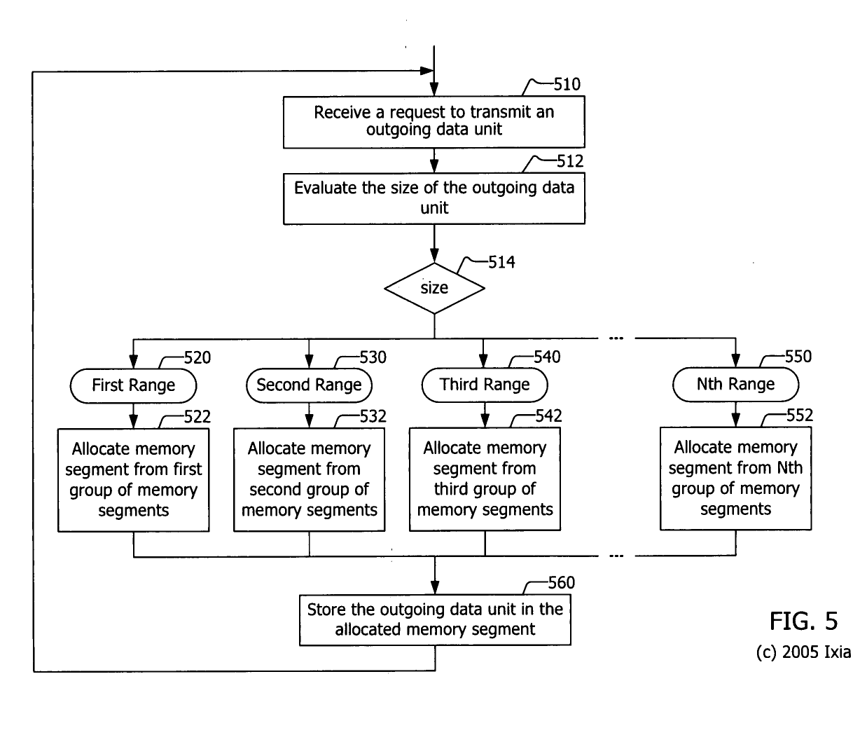

The methods described below in FIGS. 4 and 5 may be implemented by network communications units 128 and 220 of network cards 120 and 200 and network interface 314 in a network testing system 110 and computer 302 , as shown in FIGS. 1, 2 and 3, as well as in other computing devices.

FIG. 4 is a flow chart of a method performed when receiving data units in a network interface device as described herein.

Preliminarily, before a data unit is received, when the network interface in a network device such as a network card starts up or is powered on or restarts, the memory available to the memory card is pre-allocated or otherwise arranged into groups of like-sized memory segments, as set forth below. Although the term “group” is used, the terms pool, cache, buffer or other description of a portion of memory may be used to describe the functionality recited herein. Likewise, although the term “memory segment” is used, the terms cache, buffer or other description of a portion of memory may be used to describe the functionality recited herein. The groups of memory segments may be accessed and managed as multiple queues of memory segments. For example, a first group having of memory segments of a first size may be accessed via a first queue, a second group having of memory segments of a second size may be accessed via a second queue, and so on for all of the groups of memory segments. That is, there may be a queue for each group of memory segments. Other techniques may also be used to organize and manage the groups of memory segments rather than queues, including linked lists, hashes, stacks, and others.

The method may be implemented using real physical memory addresses or virtual addresses. The memory segments, although preferably contiguous areas of memory, need not be physically contiguous. A memory management unit or other technique may be implemented in software and/or in hardware to provide a contiguous virtual mapping of physical memory.

An incoming data unit is received, as shown in block 410. The size of the incoming data unit is evaluated, as shown in block 412. The flow of actions continues based on the size of the incoming data unit, as shown in block 414. A memory segment is obtained to store the incoming data unit based on the size of the incoming data unit. A memory segment of an appropriate size is allocated from one of a plurality of groups of memory segments. Each particular group of memory segments includes memory segments of an equal size. That is, a first group includes memory segments of a first size, a second group includes memory segments of a second size, and so on for the number of groups in the particular implementation. The group from which the memory segment is chosen includes memory segments at least as large as the incoming data unit. An appropriate sized memory segment is allocated to store the incoming data unit.

The number of groups of memory segments may be system defined and may be user customizable. The size of the memory segments included with each group of memory segments may be system defined and may be user customizable. The functionality described regarding FIG. 4 may be achieved in various ways, so long as the memory segment selected for the incoming data unit is at least as large as the incoming data unit.

In one embodiment, this functionality is achieved by determining into which memory segment size range group the incoming data unit fits. In this embodiment, if the size of the incoming data unit is within a first range, as shown in block 420, a memory segment from a first group of memory segments is obtained, as shown in block 422. If the size of the incoming data unit is within a second range, as shown in block 430, a memory segment from a second group of memory segments is obtained, as shown in block 432. If the size of the incoming data unit is within a third range, as shown in block 440, a memory segment from a third group of memory segments is obtained, as shown in block 442. In various embodiments, there may be as few as two groups of memory segments and may be more. Typically the number of groups is between 3 and 8, but may be more, such as, for example 12 and 16. If the size of the incoming data unit is within an Nth range, as shown in block 450, a memory segment from an Nth group of memory segments is obtained, as shown in block 452. The incoming data unit is then stored in the allocated memory segment, as shown in block 460. The allocating steps may be referred to as consuming.

After a memory segment is allocated or consumed, depending on available memory and other considerations, the group from which the memory segment was allocated may be replenished. That is, the network interface may allocate a replacement memory segment when a memory segment is consumed. In this way, the number of available, pre-allocated memory segments for the groups may remain constant, so long as memory is available.

In one embodiment, when a memory segment group has no available memory segments, is empty, the memory request may fail and memory may not be provided, resulting in a drop of the incoming data unit. In another embodiment, when a memory segment group has no available memory segments, is empty, the selection process may optionally choose a memory segment from a group of larger memory segments, if a memory segment from the group of larger memory segments is available. Even though allocating a larger memory segment will have a higher cost (by way of wasted or unused memory), it may allow the network interface to reduce or eliminate packet loss by delivering a packet which otherwise would be dropped. In one embodiment, the determination of whether the network interface may elect to drop packets for which the group of memory segments is empty or unavailable or select a larger group with an available larger memory segment is based on packet quality of service (QoS) or other run-time information. When the quality of service specific in the incoming data unit is higher, an alternate group of memory segments having larger memory segments may be selected. When the quality of service specific in the incoming data unit is lower, the incoming data unit may be dropped. The quality of service may be evaluated using other metrics and gradations. The quality of service check may be set on or off by a user of the network interface.

In one example embodiment, there are four memory segment groups sizes. The memory segments are of sizes 128 bytes, 512 bytes, 1536 bytes and 16,000 bytes. The corresponding group ranges are, therefore, from 0 to 128 bytes, 129 to 512 bytes, 513 to1,536 bytes, and 1,537 bytes to 16,000 bytes.

In other embodiments, the size of the incoming data unit may be evaluated to determine whether it is greater than, less than, greater than or equal to, or less than or equal to a minimum size or a maximum size that corresponds to the memory segment size of the memory segments in each of the groups of memory segments. In one implementation, the functionality of FIG. 4 may be achieved, for example, by checking on whether the size of the incoming data unit is less than or equal to a particular maximum size for each of the group of memory segments. As such, blocks 420, 430, 440 and 450 would recite, less than or equal to a first maximum size, a second maximum size, a third maximum, etc. until an Mth maximum, where M is equal to the total number of groups.

FIG. 5 is a flow chart of a method performed when sending data units in a network interface device as described herein. A request to transmit an outgoing data unit is received, as shown in block 510. The size of the outgoing data unit is evaluated, as shown in block 512. The flow of actions continues based on the size of the outgoing data unit, as shown in block 514. A memory segment is obtained to store the outgoing data unit based on the size of the outgoing data unit. The memory segment of an appropriate size is obtained from one of a plurality of groups of memory segments. Each particular group of memory segments includes memory segments of an equal size. That is, a first group includes memory segments of a first size, a second group includes memory segments of a second size, and so on for the number of groups in the particular implementation. The group from which the memory segment is chosen includes memory segments at least as large as the outgoing data unit. An appropriate sized memory segment is obtained to store the outgoing data unit. The number of groups of memory segments may be system defined and may be user customizable. The size of the memory segments included with each group of memory segments may be system defined and may be user customizable. The functionality described regarding FIG. 5 may be achieved in various ways, so long as the memory segment selected for the incoming data unit is at least as large as the outgoing data unit.

In one embodiment, this functionality is achieved by determining into which memory segment size range group the outgoing data unit fits. In this embodiment, if the size of the outgoing data unit is within a first range, as shown in block 520, a memory segment from a first group of memory segments is obtained, as shown in block 522. If the size of the outgoing data unit is within a second range, as shown in block 530, a memory segment from a second group of memory segments is obtained, as shown in block 432. If the size of the outgoing data unit is within a third range, as shown in block 540, a memory segment from a third group of memory segments is obtained, as shown in block 442. In various embodiments, there may be as few as three groups of memory segments and may be more. Typically the number of groups is between 3 and 8, but may be more, such as, for example 12 and 16. If the size of the outgoing data unit is within an Nth range, as shown in block 550, a memory segment from an Nth group of memory segments is obtained, as shown in block 552.

In one example embodiment, there are four memory segment groups sizes. The memory segments are of sizes 128 bytes, 512 bytes, 1536 bytes and 16,000 bytes. The corresponding group ranges are, therefore, from 0 to 128 bytes, 129 to 512 bytes, 513 to1,536 bytes, and 1,537 bytes to 16,000 bytes.

The outgoing data unit is then stored in the allocated memory segment, as shown in block 560.

In other embodiments, the size of the outgoing data unit may be evaluated to determine whether it is greater than, less than, greater than or equal to, or less than or equal to a minimum size or a maximum size that corresponds to the memory segment size of the memory segments in each of the groups of memory segments. In one implementation, the functionality of FIG. 5 may be achieved, for example, by checking on whether the size of the data unit to be transmitted is less than or equal to a particular maximum size for each of the group of memory segments. As such, blocks 520, 530, 540 and 550 would recite, less than or equal to a first maximum size, a second maximum size, a third maximum, etc. until an Mth maximum, where M is equal to the total number of groups of memory segments.

With regard to FIGS. 4 and 5, additional and fewer steps may be taken, and the steps as shown may be combined or further refined to achieve the methods described herein.

Although exemplary embodiments of the invention have been shown and described, it will be apparent to those having ordinary skill in the art that a number of changes, modifications, or alterations to the invention as described herein may be made, none of which depart from the spirit of the invention. All such changes, modifications and alterations should therefore be seen as within the scope of the invention.

It is claimed:

1. A method comprising:
receiving an incoming data unit
evaluating a size of the incoming data unit
selecting a group of memory segments from a plurality of groups of memory segments as a selected group of memory segments based on the size of the incoming data unit, the selected group of memory segments having a plurality of memory segments large enough to accommodate the incoming data unit
allocating a memory segment from the selected group of memory segments as an allocated memory segment
storing the incoming data unit in the allocated memory segment.

2. The method of claim 1 wherein each of the plurality of groups of memory segments is managed as a queue of equal sized memory segments such that each memory segment in a particular group is the same size as other memory segments in the particular group but is of a different size from other groups of memory segments.

3. The method of claim 2 wherein the selecting comprises:
determining whether the selected group of memory segments is empty
when the selected group of memory segments is empty, selecting an alternate group of memory segments having memory segments larger
than the selected group of memory segments and designating the alternate group of memory segments as the selected group of memory segments.

4. The method of claim 2 wherein the selecting comprises:
determining whether the selected group of memory segments is empty when the selected group of memory segments is empty, dropping the incoming data unit.

5. The method of claim 2 wherein the selecting comprises:
determining whether the selected group of memory segments is empty
when the selected group of memory segments is empty, evaluating a quality of service associated with the incoming data unit
when the quality of service corresponds to a higher level or is set on,
selecting an alternate group of memory segments having memory segments larger than the selected group of memory segments and
designating the alternate group of memory segments as the selected group of memory segments
when the quality of service corresponds to a lower level or is set off, dropping the incoming data unit.

6. The method of claim 1 wherein the plurality of groups of memory segments numbers between two and sixteen.

7. The method of claim 1 wherein a number of the plurality of groups of memory segments and a segment size of the memory segments in each of the plurality of groups of memory segments is customizable.

8. The method of claim 1 wherein the plurality of groups of memory segments numbers four and the plurality of groups of memory segments includes a first group of memory segments having a first size, a second group of memory segments having a second size, a third group of memory segments having a third size, and a fourth group of memory segments having a fourth size.

9. The method of claim 1 wherein the plurality of groups of memory segments numbers five and the plurality of groups of memory segments includes a first group of memory segments having a first size, a second group of memory segments having a second size, a third group of memory segments having a third size, a fourth group of memory segments having a fourth size, and a fifth group of memory segments having a fifth size.

10. A hardware device configured to handle network communications and to perform actions comprising:
receiving an incoming data unit
evaluating a size of the data unit
selecting a group of memory segments from a plurality of groups of memory segments as a selected group of memory segments based on the size of the incoming data unit, the selected group of memory segments having a plurality of memory segments large enough to accommodate the incoming data unit
allocating a memory segment from the selected group of memory segments as an allocated memory segment
storing the incoming data unit in the allocated memory segment.

11. The hardware device of claim 10 wherein each of the plurality of groups of memory segments is managed as a queue of equal sized memory segments such that each memory segment in a particular group is the same size as other memory segments in the particular group but is of a different size from other groups of memory segments.

12. The hardware device of claim 11 wherein the selecting comprises:
determining whether the selected group of memory segments is empty
when the selected group of memory segments is empty,
selecting an alternate group of memory segments having memory segments larger than the selected group of memory segments and
designating the alternate group of memory segments as the selected group of memory segments.

13. The hardware device of claim 11 wherein the selecting comprises:
determining whether the selected group of memory segments is empty
when the selected group of memory segments is empty, dropping the incoming data unit.

14. The hardware device of claim 11 wherein the selecting comprises:
determining whether the selected group of memory segments is empty
when the selected group of memory segments is empty, evaluating a quality of service associated with the incoming data unit
when the quality of service corresponds to a higher level or is set on,
selecting an alternate group of memory segments having memory segments larger than the selected group of memory segments and
designating the alternate group of memory segments as the selected group of memory segments
when the quality of service corresponds to a lower level or is set off, dropping the incoming data unit.

15. The hardware device of claim 10 wherein the plurality of groups of memory segments numbers between two and sixteen.

16. The hardware device of claim 10 wherein a number of the plurality of groups of memory segments and a segment size of the memory segments in each of the plurality of groups of memory segments is customizable.

17. The hardware device of claim 10 wherein the plurality of groups of memory segments numbers four and the plurality of groups of memory segments includes a first group of memory segments having a first size, a second group of memory segments having a second size, a third group of memory segments having a third size, and a fourth group of memory segments having a fourth size.

18. The hardware device of claim 10 wherein the plurality of groups of memory segments numbers five and the plurality of groups of memory segments includes a first group of memory segments having a first size, a second group of memory segments having a second size, a third group of memory segments having a third size, a fourth group of memory segments having a fourth size, and a fifth group of memory segments having a fifth size.

19. A network card having the hardware device of claim 10 included thereon.

20. A network testing system having at least one network card of claim 19 included thereon.

21. A computer having at least one of the network cards of claim 19 included therewith.

22. A computing device having the hardware device of claim 10 included therewith.
